(19) United States
(12) Patent Application Publication
(10) Pub. No.: US 2018/0292965 A1
(43) Pub. Date: Oct. 11, 2018

(54) CONTROLLER AND CONTROL METHOD

(71) Applicant: FANUC CORPORATION, Yamanashi (JP)

(72) Inventor: Hideki Sasamoto, Minamitsuru-gun (JP)

(73) Assignee: FANUC CORPORATION, Yamanashi (JP)

(21) Appl. No.: 15/944,893

(22) Filed: Apr. 4, 2018

(30) Foreign Application Priority Data
Apr. 7, 2017 (JP) 2017-076418
Mar. 28, 2018 (JP) 2018-061456

(51) Int. Cl. G06F 3/0488; G06F 3/041

(52) U.S. Cl. CPC G06F 3/0488; G06F 3/0412

(57) ABSTRACT

A controller for controlling a display device including a touch panel that is attached to a screen of a display unit for displaying an image of an operation element, and that detects a position pressed by an operator as an operation coordinate point includes a coordinate region setting unit that sets a coordinate region on the touch panel and that, if the operation coordinate point detected when the touch panel is pressed is out of the coordinate region and thereafter at the time of pressing the touch panel, the detected operation coordinate point is within the coordinate region, expands the coordinate region to a region containing the operation coordinate point that is out of the coordinate region.

### CROSS-REFERENCE TO RELATED APPLICATION

This application is based upon and claims the benefit of priority from Japanese Patent Application No. 2017-076418 filed on Apr. 7, 2017 and No. 2018-061456 filed on Mar. 28, 2018, the contents of which are incorporated herein by reference.

### BACKGROUND OF THE INVENTION

### Field of the Invention

The present invention relates to a controller including a touch panel attached to a screen of a display unit, and a control method.

### Description of the Related Art

In Japanese Laid-Open Patent Publication No. 2010-176234, a deviation between display coordinates of a display device and touch panel pressed coordinates, which is caused by a difference in viewing angle of a user, is automatically corrected.

### SUMMARY OF THE INVENTION

A controller for controlling a display device determines that, when an operator presses a touch panel at a position of an icon (operation element) displayed on a display (display unit), the icon has been operated. If there is a local deviation in regard to the coordinates of the pressed point output from the touch panel, the technique according to Japanese Laid-Open Patent Publication No. 2010-176234 cannot correct such a deviation, and even if the operator presses the touch panel at the position of the icon, the controller may fail to determine that the icon has been operated.

The present invention has been made in order to solve the above problem, and an object of the present invention is to provide a controller and a control method capable of correctly determining that an operation element has been operated.

An aspect of the present invention is a controller for controlling a display device including a display unit configured to display an image of an operation element, and a touch panel attached to a screen of the display unit and configured to detect a position pressed by an operator as an operation coordinate point, the controller including: a coordinate region setting unit configured to set a coordinate region on the touch panel corresponding to the operation element, and if the operation coordinate point detected when the touch panel is pressed is out of the coordinate region and thereafter at the time of pressing the touch panel, the detected operation coordinate point is within the coordinate region, expand the coordinate region to a region containing the operation coordinate point that is out of the coordinate region; and an operation determination unit configured to determine, if the detected operation coordinate point is within the coordinate region, the operation element has been operated.

According to the present invention, it is possible to determine correctly that the operation element has been operated.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a schematic diagram of a touch panel display;

FIG. 2 is a block diagram illustrating a configuration of a computer numerical controller (CNC) including the touch panel display;

FIG. 3 is a flowchart showing an expansion process of a touch panel coordinate region performed in a coordinate region setting unit;

FIG. 4A is a schematic diagram of the touch panel display in an unexpanded state of the touch panel coordinate region;

FIG. 4B is a schematic diagram of the touch panel display in an expanded state of the touch panel coordinate region;

FIG. 5 is a schematic diagram of the touch panel display;

FIG. 6 is a flowchart showing an expansion process of the touch panel coordinate region performed in the coordinate region setting unit;

FIG. 7A is a schematic diagram of the touch panel display in an unexpanded state of the touch panel coordinate region; and

FIG. 7B is a schematic diagram of the touch panel display in an expanded state of the touch panel coordinate region.

### DESCRIPTION OF THE PREFERRED EMBODIMENTS

The present invention will be described based on embodiments. The embodiments to be described below are not intended to limit the present invention as defined in the appended claims. Furthermore, all of the combinations of features described in the embodiments are not necessarily essential for achieving the solution of the present invention.

### First Embodiment

[Touch Panel Display]

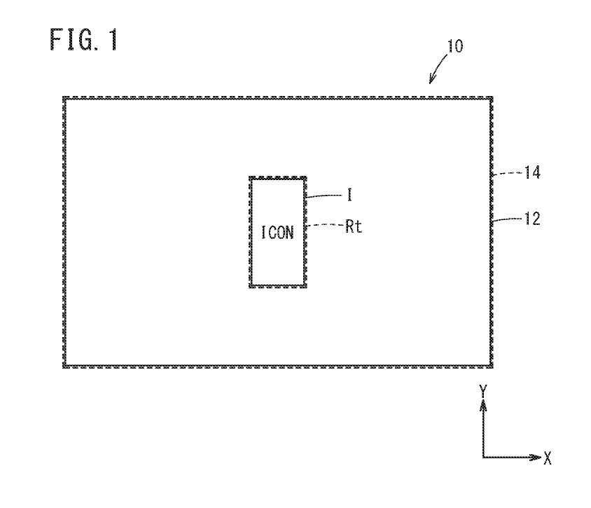

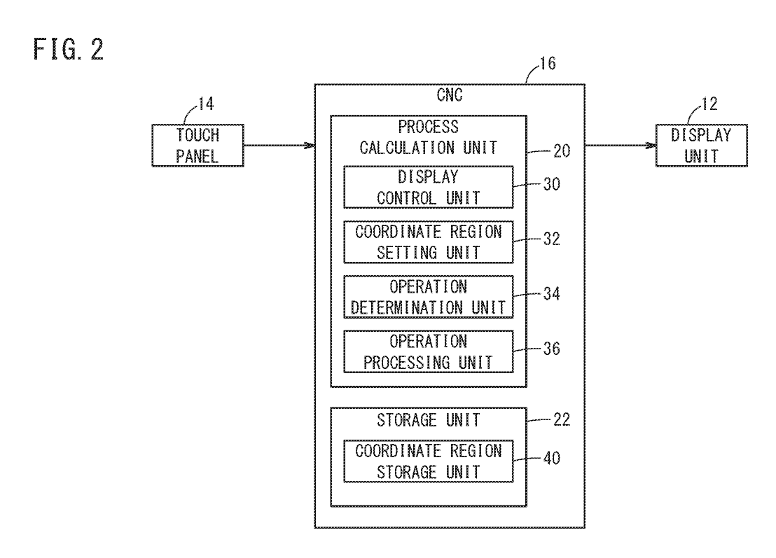

FIG. 1 is a schematic diagram of a touch panel display (display device) 10. The touch panel display 10 includes a display unit 12 and a touch panel 14. The touch panel display 10 according to the present embodiment is mounted on a computer numerical controller (CNC) 16 (FIG. 2) that controls, for example, a machine tool.

The display unit 12 is, for example, a liquid crystal display, and can display characters, symbols, figures, and images. The touch panel 14 is a member in the form of a transparent sheet that is attached to a screen of the display unit 12, and is a resistive type touch panel, for example. The touch panel 14 detects and outputs a position where the touch panel 14 is pressed with a finger of an operator, a pen or the like, as coordinates (a coordinate point) on an XY coordinate plane. Coordinates (a coordinate point) of the position where the touch panel 14 is pressed with a finger of the operator, a pen, or the like are referred to as operation coordinates (an operation coordinate point).

FIG. 2 is a block diagram illustrating a configuration of the CNC 16 including the touch panel display 10 (display unit 12, touch panel 14). The CNC 16 includes a process calculation unit 20 and a storage unit 22. The process calculation unit 20 includes a processor, a memory, and the like, and performs various processes and calculations, for example. The storage unit 22 is a semiconductor memory or the like, and stores various data.

The process calculation unit 20 includes a display control unit 30, a coordinate region setting unit 32, an operation determination unit 34, and an operation processing unit 36. The display control unit 30 outputs a control signal to the display unit 12 so as to display an icon I on the display unit 12. The coordinate region setting unit 32 sets a coordinate region on the touch panel 14 that corresponds to the icon I displayed on the display unit 12 (hereinafter, the coordinate region is referred to as a touch panel coordinate region Rt).

When the touch panel 14 is pressed by the operator and the operation coordinate point is within the touch panel coordinate region Rt, the operation determination unit 34 determines that the icon I has been operated. When the icon I is operated, the operation processing unit 36 performs a process that is assigned in advance to the icon I. The process assigned in advance includes, for example, a process to input a cutting condition of a machine tool and then store the input cutting condition in the storage unit 22, a process to switch a screen of the display unit 12 to another screen, or the like. The storage unit 22 includes a coordinate region storage unit 40. The coordinate region storage unit 40 stores the touch panel coordinate region Rt set by the coordinate region setting unit 32.

[Touch Panel Coordinate Region Expansion Process]

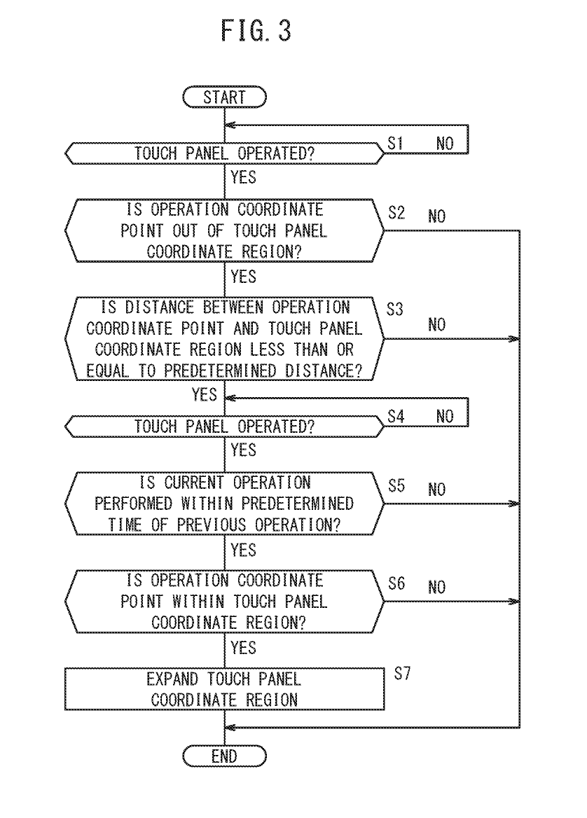

After the touch panel coordinate region Rt is set, the coordinate region setting unit 32 expands the touch panel coordinate region Rt if a predetermined condition is satisfied. FIG. 3 is a flowchart for describing an expansion process of the touch panel coordinate region Rt performed in the coordinate region setting unit 32.

In step S1, the coordinate region setting unit 32 determines whether the touch panel 14 has been operated (pressed) by an operator. If the touch panel 14 has been operated, the process proceeds to step S2. If the touch panel 14 has not been operated, the process in step S1 is repeated.

In step S2, the coordinate region setting unit 32 determines whether the operation coordinate point is out of the touch panel coordinate region Rt. If the operation coordinate point is out of the touch panel coordinate region Rt, the process proceeds to step S3. If the operation coordinate point is within the touch panel coordinate region Rt, the process is put to an end.

In step S3, the coordinate region setting unit 32 determines whether a distance between the operation coordinate point and the touch panel coordinate region Rt is less than or equal to a predetermined distance (for example, 1 [cm]). If the distance between the operation coordinate point and the touch panel coordinate region Rt is less than or equal to the predetermined distance, the process proceeds to step S4. If the distance between the operation coordinate point and the touch panel coordinate region Rt is greater than the predetermined distance, the process is put to an end.

In step S4, the coordinate region setting unit 32 determines whether the touch panel 14 has been operated by the operator. If the touch panel 14 has been operated, the process proceeds to step S5. If the touch panel 14 has not been operated, the process in step S4 is repeated.

In step S5, the coordinate region setting unit 32 determines whether a time from the previous operation of the touch panel 14 by the operator to the current operation of the touch panel 14 by the operator falls within a predetermined time (for example, 1 [sec]). If the time falls within the predetermined time, the process proceeds to step S6. If the time does not fall within the predetermined time, the process is brought to an end.

In step S6, the coordinate region setting unit 32 determines whether the operation coordinate point is within the touch panel coordinate region Rt. If the operation coordinate point is within the touch panel coordinate region Rt, the process proceeds to step S7. If the operation coordinate point is out of the touch panel coordinate region Rt, the process is brought to an end.

In step S7, the touch panel coordinate region Rt is expanded to a region including the operation coordinate point that is out of the touch panel coordinate region Rt, and the process is put to an end.

[Operation Effect]

Before the touch panel display 10 is shipped or when the touch panel display 10 is used for the first time after the CNC 16 has been installed in a factory, calibration is performed so that the operation coordinate point detected by the touch panel 14 and a display position on the display unit 12 coincide with each other. By this calibration, when the operator presses the touch panel 14 at a position of an icon I displayed on the display unit 12, the operation coordinate point detected by the touch panel 14 is within the touch panel coordinate region Rt. Thus, the operation determination unit 34 determines that the icon I has been operated.

However, due to aged deterioration or the like of the touch panel 14, such a case may occur that the operation coordinate point detected by the touch panel 14 may deviate from the display position on the display unit 12. Therefore, even though the operator presses the touch panel 14 at the position of the icon I displayed on the display unit 12, the operation coordinate point detected by the touch panel 14 is out of the touch panel coordinate region Rt. Consequently, the operation determination unit 34 may fail to determine that the icon I has been operated.

If the operation coordinate point detected by the touch panel 14 deviates, as a whole, in one direction from the display position on the display unit 12, such a deviation can be eliminated by performing the calibration described above. However, a deviation due to aged deterioration or the like of the touch panel 14 may occur locally. In this case, eliminating a deviation at a certain position by performing the calibration may cause a deviation at another position disadvantageously.

In view of the above, in the present embodiment, even if the operation coordinate point detected by the touch panel 14 deviates locally from the display position on the display unit 12, the operation determination unit 34 can determine correctly operation of the icon I by expanding the touch panel coordinate region Rt.

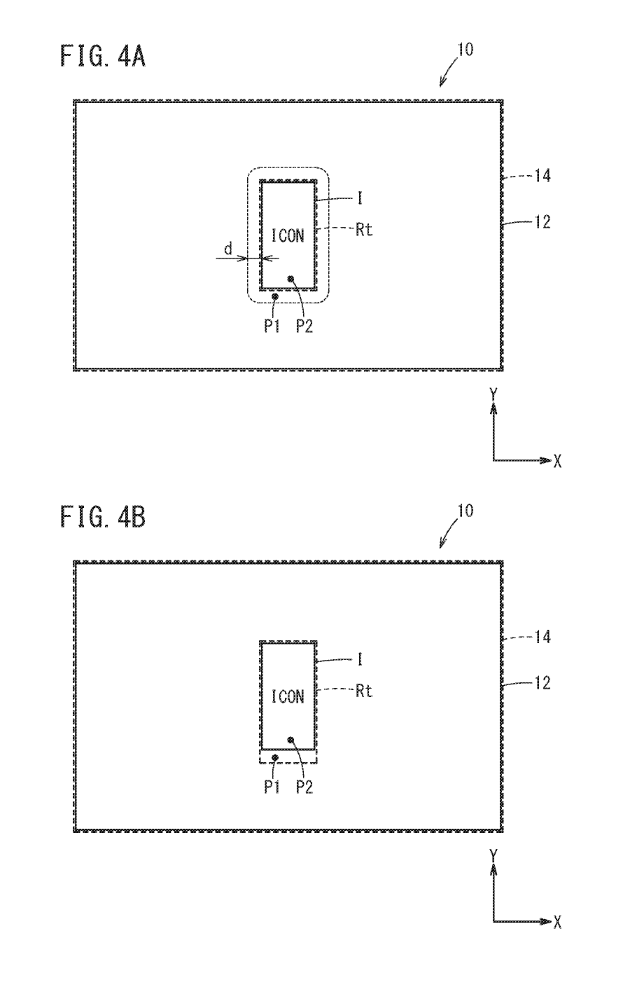

The expansion of the touch panel coordinate region Rt will be described below based on a specific example. FIG. 4A is a schematic diagram of the touch panel display 10 in an unexpanded state of the touch panel coordinate region Rt. FIG. 4B is a schematic diagram of the touch panel display 10 in an expanded state of the touch panel coordinate region Rt.

Although the operator presses the touch panel 14 at the position of the icon I displayed on the display unit 12, the operation coordinate point detected by the touch panel 14 is a coordinate point P1 that is out of the touch panel coordinate region Rt (FIG. 4A). Next, the operator slightly shifts the pressed position on the touch panel 14, and as a result, the operation coordinate point detected by the touch panel 14 becomes a coordinate point P2 that is within the touch panel coordinate region Rt (FIG. 4A).

In this case, if a time from the operation of the touch panel 14 at the position where the operation coordinate point is the coordinate point P1 to the operation of the touch panel 14 at the position where the operation coordinate point is the coordinate point P2 falls within the predetermined time, and a distance between the coordinate point P1 and the touch panel coordinate region Rt is less than or equal to a predetermined distance d, then the coordinate region setting unit 32 expands the touch panel coordinate region Rt to a region including the coordinate point P1 (FIG. 4B).

When the operator presses the touch panel 14 at the position of an icon I displayed on the display unit 12, an operation that is associated with the icon I by the CNC 16 is not performed in some cases. In such cases, the operator tends to press the touch panel 14 many times during a short period of time while shifting the touching position little by little. In the present embodiment, when the touch panel 14 is operated at a position where the operation coordinate point is out of the touch panel coordinate region Rt and thereafter the touch panel 14 is operated at a position where the operation coordinate point is within the touch panel coordinate region Rt, the touch panel coordinate region Rt is expanded to the region including the operation coordinate point that is out of the touch panel coordinate region Rt. Therefore, even when the operation coordinate point detected by the touch panel 14 deviates from the display position, the operation determination unit 34 determines correctly whether the icon I has been operated or not.

In addition, if the distance between the operation coordinate point and the touch panel coordinate region Rt is less than or equal to the predetermined distance, the touch panel coordinate region Rt is expanded. When the operation coordinate point is far from the touch panel coordinate region Rt, it is presumed that the operator has performed an erroneous operation or tries to perform an operation other than the icon I. Therefore, it is possible to avoid a situation that the operation determination unit 34 mistakenly determines that the other operation is the operation of the icon I.

Furthermore, if a time from the pressing of the touch panel 14 at the position where the operation coordinate point is out of the touch panel coordinate region Rt to the pressing of the touch panel 14 at the position where the operation coordinate point is within the touch panel coordinate region Rt falls within the predetermined time, then the touch panel coordinate region Rt is expanded. If the time from the pressing of the touch panel 14 to the next pressing of the touch panel 14 is long, it is presumed that in the previous pressing of the touch panel 14, the operator tried to perform an operation other than the icon I. Therefore, it is possible to avoid a situation that the operation determination unit 34 mistakenly determines that the other operation is the operation of the icon I.

### Second Embodiment

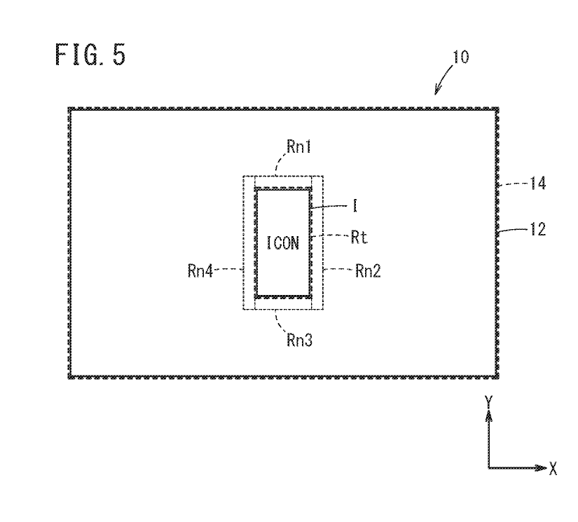

FIG. 5 is a schematic diagram of the touch panel display 10. In a second embodiment, a plurality of adjacent coordinate regions Rn1 to Rn4 is provided adjacent to the touch panel coordinate region Rt. In addition, the touch panel coordinate region Rt is expanded so as to contain, from among the adjacent coordinate regions Rn1 to Rn4, one or more of the adjacent coordinate regions Rn1 to Rn4 for which the number of times of occurrence of the operation coordinate point within the one or more adjacent coordinate regions Rn1 to Rn4 is greater than or equal to a predetermined number of times.

[Touch Panel Coordinate Region Expansion Process]

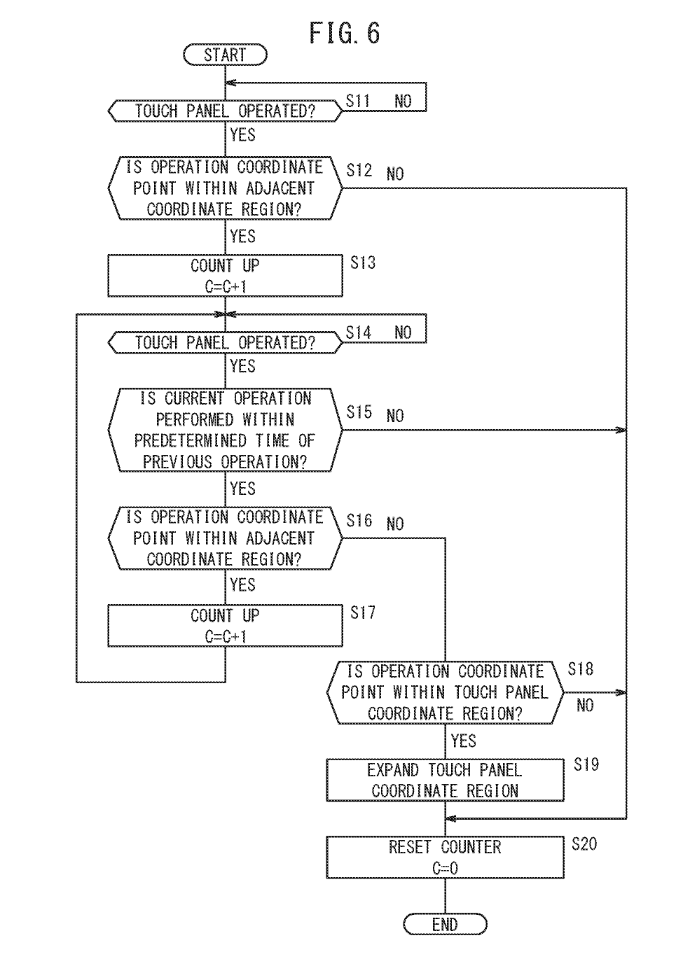

FIG. 6 is a flowchart for describing an expansion process of the touch panel coordinate region Rt performed in the coordinate region setting unit 32.

In step S11, the coordinate region setting unit 32 determines whether the touch panel 14 has been operated (pressed) by the operator. If the touch panel 14 has been operated, the process proceeds to step S12. If the touch panel 14 has not been operated, the process in step S11 is repeated.

In step S12, the coordinate region setting unit 32 determines whether the operation coordinate point is within one of the adjacent coordinate regions Rn1 to Rn4. If the operation coordinate point is within one of the adjacent coordinate regions Rn1 to Rn4, the process proceeds to step S13. If the operation coordinate point is not within any of the adjacent coordinate regions Rn1 to Rn4, the process proceeds to step S20.

In step S13, the coordinate region setting unit 32 increments a counter C (C1 to C4) that counts the number of times that the operation coordinate point occurs within the one of the adjacent coordinate regions Rn1 to Rn4, and the process proceeds to step S14. For example, if the operation coordinate point is within the adjacent coordinate region Rn1 in the determination of step S12, the counter C1 is incremented, and if the operation coordinate point is within the adjacent coordinate region Rn2 in the determination of step S12, the counter C2 is incremented.

In step S14, the coordinate region setting unit 32 determines whether the touch panel 14 has been operated by the operator. If the touch panel 14 has been operated, the process proceeds to step S15. If the touch panel 14 has not been operated, the process in step S14 is repeated.

In step S15, the coordinate region setting unit 32 determines whether a time from the previous operation of the touch panel 14 by the operator to the current operation of the touch panel 14 by the operator falls within a predetermined time (for example, 1 [sec]). If the time falls within the predetermined time, the process proceeds to step S16. If the time does not fall within the predetermined time, the process proceeds to step S20.

In step S16, the coordinate region setting unit 32 determines whether the operation coordinate point is within one of the adjacent coordinate regions Rn1 to Rn4. If the operation coordinate point is within one of the adjacent coordinate regions Rn1 to Rn4, the process proceeds to step S17. If the operation coordinate point is not within any of the adjacent coordinate regions Rn1 to Rn4, the process proceeds to step S18.

In step S17, the coordinate region setting unit 32 increments the counter C (C1 to C4) that counts the number of times of occurrence of the operation coordinate point within the one of the adjacent coordinate regions Rn1 to Rn4, and the process returns to step S14.

In step S18, the coordinate region setting unit 32 determines whether the operation coordinate point is within the touch panel coordinate region Rt. If the operation coordinate point is within the touch panel coordinate region Rt, the process proceeds to step S19. If the operation coordinate point is out of the touch panel coordinate region Rt, the process proceeds to step S20.

In step S19, the coordinate region setting unit 32 obtains, from each counter C, the number of times that the operation coordinate point occurs within each of the adjacent coordinate regions Rn1 to Rn4, and expands the touch panel coordinate region Rt so as to contain one or more of the adjacent coordinate regions Rn1 to Rn4 for which the number of times of occurrence of the operation coordinate point within the one or more of the adjacent coordinate regions Rn1 to Rn4 is greater than or equal to a predetermined number of times (for example, three times). Then, the process proceeds to step S20.

In step S20, the coordinate region setting unit 32 resets the counter C (C1 to C4), and then the process is brought to an end.

[Operation Effect]

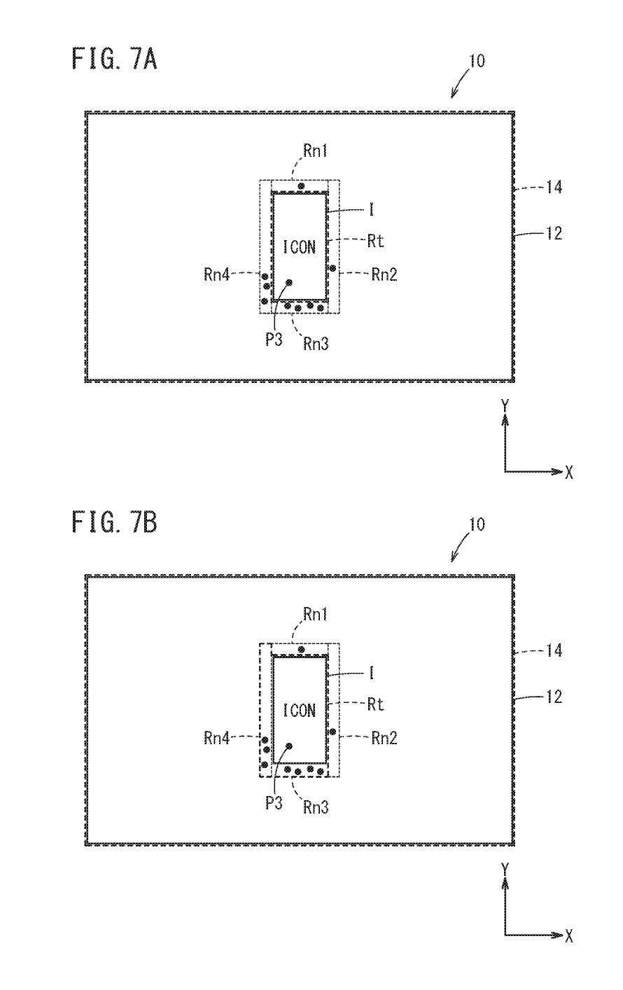

The expansion of the touch panel coordinate region Rt will be described below with reference to a specific example. FIG. 7A is a schematic diagram of the touch panel display 10 in an unexpanded state of the touch panel coordinate region Rt. FIG. 7B is a schematic diagram of the touch panel display 10 in an expanded state of the touch panel coordinate region Rt.

The operator presses the touch panel 14 nine times at the position of an icon I displayed on the display unit 12, and all of the operation coordinate points detected by the touch panel 14 in the nine pressing operations are within the adjacent coordinate regions Rn1 to Rn4. The number of times that the operation coordinate point occurs within the adjacent coordinate region Rn1 is one (C1=1), the number of times that the operation coordinate point occurs within the adjacent coordinate region Rn2 is one (C2=1), the number of times that the operation coordinate point occurs within the adjacent coordinate region Rn3 is four (C3=4), and the number of times that the operation coordinate point occurs within the adjacent coordinate region Rn4 is three (C4=3) (FIG. 7A). In the operator's tenth pressing operation on the touch panel 14, the operation coordinate point detected by the touch panel 14 is a coordinate point P3 within the touch panel coordinate region Rt (FIG. 7A).

In this case, if the operator's tenth operation of the touch panel 14 is performed within a predetermined time from the ninth operation, the coordinate region setting unit 32 expands the touch panel coordinate region Rt so as to contain the adjacent coordinate regions Rn3 and Rn4 (FIG. 7B).

When the operator presses the touch panel 14 at the position of an icon I displayed on the display unit 12, an operation that is associated with the icon I by the CNC 16 is not performed in some cases. In such cases, the operator tends to repeatedly press the same position several times. In view of this, the touch panel coordinate region Rt is expanded so as to include one or more of the adjacent coordinate regions Rn1 to Rn4 for which the number of times of occurrence of the operation coordinate point within the one or more of the adjacent coordinate regions Rn1 to Rn4 is large. Thus, an erroneous determination by the operation determination unit 34 can be suppressed without unnecessarily expanding the touch panel coordinate region Rt.

### OTHER EMBODIMENTS

While the present invention has been described with reference to the embodiments, the technical scope of the present invention is not limited to the scope described in the above embodiments. It goes without saying that various modifications or improvements can be added to the above embodiments. It is clear from the scope of the claims that other modes to which such modifications or improvements have been added can be included within the technical scope of the present invention.

In the first embodiment, if the distance between the operation coordinate point and the touch panel coordinate region Rt is less than or equal to the predetermined distance, the touch panel coordinate region Rt is expanded. In addition, the touch panel coordinate region Rt may be expanded even if the distance between the operation coordinate point and the touch panel coordinate region Rt is greater than the predetermined distance.

Furthermore, in the first embodiment and the second embodiment, if the time from the previous operation of the touch panel 14 to the current operation of the touch panel 14 falls within the predetermined time, the touch panel coordinate region Rt is expanded. In addition, the touch panel coordinate region Rt may be expanded even if the time from the previous operation of the touch panel 14 to the current operation of the touch panel 14 is longer than the predetermined time.

[Technical Concept Obtained from the Embodiments]

The technical concept which can be grasped from the above embodiments will be described below.

The controller (16) for controlling the display device (10) including the display unit (12) configured to display an image of the operation element (I), and the touch panel (14) attached to a screen of the display unit (12) and configured to detect a position pressed by an operator as an operation coordinate point, the controller (16) includes: the coordinate region setting unit (32) configured to set a coordinate region (Rt) on the touch panel (14) corresponding to the operation element (I), and that if the operation coordinate point detected when the touch panel (14) is pressed is out of the coordinate region (Rt) and thereafter at the time of pressing on the touch panel (14), the detected operation coordinate point is within the coordinate region (Rt), expand the coordinate region (Rt) to a region containing the operation coordinate point that is out of the coordinate region (Rt); and the operation determination unit (34) configured to determine, if the detected operation coordinate point is within the coordinate region (Rt), the operation element (I) has been operated. Thus, even when a local deviation occurs in regard to the operation coordinate point detected by the touch panel (14), the operation determination unit (34) can correctly determine whether the operation element (I) has been operated.

In the controller (16), if the operation coordinate point detected when the touch panel (14) is pressed is out of the coordinate region (Rt) while a distance between the operation coordinate point and the coordinate region (Rt) is less than or equal to a predetermined distance and thereafter at the time of pressing the touch panel (14), the detected operation coordinate is within the coordinate region (Rt), then the coordinate region setting unit (32) may expand the coordinate region (Rt) to the region containing the operation coordinate point that is out of the coordinate region (Rt). Thus, it is possible to prevent the operation determination unit (34) from mistakenly determining that another operation by the operator is the operation of the operation element (I).

In the controller (16), if the operation coordinate point detected when the touch panel (14) is pressed is out of the coordinate region (Rt) and thereafter at the time of pressing the touch panel (14) within a predetermined time, the detected operation coordinate point is within the coordinate region (Rt), then the coordinate region setting unit (32) may expand the coordinate region (Rt) to the region containing the operation coordinate point that is out of the coordinate region (Rt). Thus, it is possible to prevent the operation determination unit (34) from mistakenly determining that the other operation by the operator is the operation of the operation element (I).

In the controller (16), the coordinate region setting unit (32) may set in advance a plurality of adjacent coordinate regions (Rn1 to Rn4) adjacent to the coordinate region (Rt), and if the operation coordinate point detected when the touch panel (14) is pressed is within one of the adjacent coordinate regions (Rn1 to Rn4) and thereafter at the time of pressing the touch panel (14), the detected operation coordinate point is within the coordinate region (Rt), then the coordinate region setting unit (32) may expand the coordinate region (Rt) so as to contain, from among the plurality of adjacent coordinate regions (Rn1 to Rn4), an adjacent coordinate region (Rn1 to Rn4) for which the number of times of occurrence of the operation coordinate point within the adjacent coordinate region (Rn1 to Rn4) is greater than or equal to a predetermined number of times. Thus, an erroneous determination by the operation determination unit (34) can be suppressed without unnecessarily expanding the touch panel coordinate region (Rt).

The control method for a display device (10) including the display unit (12) configured to display an image of an operation element (I), and a touch panel (14) attached to a screen of the display unit (12) and configured to detect a position pressed by an operator as an operation coordinate point, includes the steps of setting a coordinate region (Rt) on the touch panel (14) corresponding to the operation element (I) and if the operation coordinate point detected when the touch panel (14) is pressed is out of the coordinate region (Rt) and thereafter at the time of pressing the touch panel (14), the detected operation coordinate point is within the coordinate region (Rt), expanding the coordinate region (Rt) to a region containing the operation coordinate point that is out of the coordinate region (Rt), and determining that, if the detected operation coordinate point is within the coordinate region (Rt), the operation element (I) has been operated. Thus, even when a local deviation occurs in regard to the operation coordinate point detected by the touch panel (14), it can be correctly determined whether the operation element (I) has been operated.

In the above control method, if the operation coordinate point detected when the touch panel (14) is pressed is out of the coordinate region (Rt) while a distance between the operation coordinate point and the coordinate region (Rt) is less than or equal to a predetermined distance, and thereafter at the time of pressing the touch panel (14), the detected operation coordinate point is within the coordinate region (Rt), then the coordinate region (Rt) may be expanded to the region containing the operation coordinate point that is out of the coordinate region (Rt). Thus, it is possible to prevent the operation determination unit (34) from mistakenly determining that the other operation by the operator is the operation of the operation element (I).

In the above control method, if the operation coordinate point detected when the touch panel (14) is pressed is out of the coordinate region (Rt) and thereafter at the time of pressing the touch panel (14) within a predetermined time, the detected operation coordinate point is within the coordinate region (Rt), then the coordinate region (Rt) may be expanded to the region containing the operation coordinate point that is out of the coordinate region (Rt). Thus, it is possible to prevent the operation determination unit (34) from mistakenly determining that the other operation by the operator is the operation of the operation element (I).

In the above control method, a plurality of adjacent coordinate regions (Rn1 to Rn4) adjacent to the coordinate region (Rt) may be set in advance, and if the operation coordinate point detected when the touch panel (14) is pressed is within one of the adjacent coordinate regions (Rn1 to Rn4) and thereafter at the time of pressing the touch panel (14), the detected operation coordinate point is within the coordinate region (Rt), then the coordinate region (Rt) may be expanded so as to contain, from among the plurality of adjacent coordinate regions (Rn1 to Rn4), an adjacent coordinate region (Rn1 to Rn4) for which the number of times of occurrence of the operation coordinate point within the adjacent coordinate region (Rn1 to Rn4) is greater than or equal to a predetermined number of times. Thus, an erroneous determination with respect to the operation of the operation element (I) can be suppressed without unnecessarily expanding the touch panel coordinate region (Rt).

What is claimed is:

1. A controller for controlling a display device including a display unit configured to display an image of an operation element, and a touch panel attached to a screen of the display unit and configured to detect a position pressed by an operator as an operation coordinate point, the controller comprising:
a coordinate region setting unit configured to set a coordinate region on the touch panel corresponding to the operation element, and if the operation coordinate point detected when the touch panel is pressed is out of the coordinate region and thereafter at a time of pressing of the touch panel, the detected operation coordinate point is within the coordinate region, expand the coordinate region to a region containing the operation coordinate point that is out of the coordinate region; and
an operation determination unit configured to determine, if the detected operation coordinate point is within the coordinate region, the operation element has been operated.

2. The controller according to claim 1, wherein if the operation coordinate point detected when the touch panel is pressed is out of the coordinate region while a distance between the operation coordinate point and the coordinate region is less than or equal to a predetermined distance, and thereafter at a time of pressing the touch panel, the detected operation coordinate point is within the coordinate region, then the coordinate region setting unit expands the coordinate region to the region containing the operation coordinate point that is out of the coordinate region.

3. The controller according to claim 1, wherein if the operation coordinate point detected when the touch panel is pressed is out of the coordinate region and thereafter at a time of pressing the touch panel within a predetermined time, the detected operation coordinate point is within the coordinate region, then the coordinate region setting unit expands the coordinate region to the region containing the operation coordinate point that is out of the coordinate region.

4. The controller according to claim 1, wherein the coordinate region setting unit sets in advance a plurality of adjacent coordinate regions adjacent to the coordinate region, and if the operation coordinate point detected when the touch panel is pressed is within one of the adjacent coordinate regions and thereafter at a time of pressing the touch panel, the detected operation coordinate point is within the coordinate region, then the coordinate region setting unit expands the coordinate region so as to contain, from among the plurality of adjacent coordinate regions, an adjacent coordinate region for which number of times of occurrence of the operation coordinate point within the adjacent coordinate region is greater than or equal to a predetermined number of times.

5. A control method for a display device including a display unit configured to display an image of an operation element, and a touch panel attached to a screen of the display unit and configured to detect a position pressed by an operator as an operation coordinate point, the control method comprising the steps of:
setting a coordinate region on the touch panel corresponding to the operation element, and if the operation coordinate point detected when the touch panel is pressed is out of the coordinate region and thereafter at a time of pressing the touch panel, the detected operation coordinate point is within the coordinate region, expanding the coordinate region to a region containing the operation coordinate point that is out of the coordinate region; and
determining that, if the detected operation coordinate point is within the coordinate region, the operation element has been operated.

6. The control method according to claim 5, wherein if the operation coordinate point detected when the touch panel is pressed is out of the coordinate region while a distance between the operation coordinate point and the coordinate region is less than or equal to a predetermined distance, and thereafter at a time of pressing the touch panel, the detected operation coordinate point is within the coordinate region, then the coordinate region is expanded to the region containing the operation coordinate point that is out of the coordinate region.

7. The control method according to claim 5, wherein if the operation coordinate point detected when the touch panel is pressed is out of the coordinate region and thereafter at a time of pressing the touch panel within a predetermined time, the detected operation coordinate point is within the coordinate region, then the coordinate region is expanded to the region containing the operation coordinate point that is out of the coordinate region.

8. The control method according to claim 5, wherein a plurality of adjacent coordinate regions adjacent to the coordinate region are set in advance, and if the operation coordinate point detected when the touch panel is pressed is within one of the adjacent coordinate regions and thereafter at a time of pressing the touch panel, the detected operation coordinate point is within the coordinate region, then the coordinate region is expanded so as to contain, from among the plurality of adjacent coordinate regions, an adjacent coordinate region for which number of times of occurrence of the operation coordinate point within the adjacent coordinate region is greater than or equal to a predetermined number of times.
